(19) United States
(12) Patent Application Publication
(10) Pub. No.: US 2026/0037989 A1
(43) Pub. Date: Feb. 5, 2026

(54) System and Related Method for Automating Security Compliance Monitoring and Remediation

(71) Applicants: Ramkumar Sundarakalatharan, Egham (GB); Rajeshwar Dhayalan, Chennai (IN); Aravintharaj Govindarajan, Chennai (IN)

(72) Inventors: Ramkumar Sundarakalatharan, Egham (GB); Rajeshwar Dhayalan, Chennai (IN); Aravintharaj Govindarajan, Chennai (IN)

(21) Appl. No.: 18/791,480

(22) Filed: Aug. 1, 2024

(51) Int. Cl. G06Q 30/018

(52) U.S. Cl. CPC G06Q 30/018

(57) ABSTRACT

The present invention provides a system for automating security compliance monitoring. The system comprises auto-discovery agents interfacing with various computing environments to collect and transmit configuration and status data, a repository containing templates for compliance standards, and a data repository for storing control status information. It includes a real-time monitoring system to analyze collected data, identify deviations, generate alerts, and log events. An engine executes automated remedial actions, and a client with an embedded monitoring agent collects compliance data for transmission to the real-time monitoring system. An interface is configured for executing remedial actions with restricted access and action logging. The system enhances compliance management by providing continuous monitoring, real-time alerts, and automated remediation, integrating various IT environments, and ensuring secure data transmission and storage.

### FIELD OF INVENTION

The present invention relates generally to systems and methods for automating security compliance monitoring and remediation, specifically designed to ensure continuous compliance with industry standards.

### BACKGROUND

The advent of digital transformation has seen organizations increasingly rely on cloud-based services and complex IT infrastructures to support their operations. With this shift, ensuring security compliance with various industry standards such as ISO27001, PCI-DSS, HIPAA, and GDPR has become a critical concern. Traditional methods of compliance monitoring and remediation are predominantly manual, involving substantial time, resources, and cost. These manual processes are not only inefficient but also prone to human error, leading to potential non-compliance and the associated risks of data breaches, regulatory fines, and reputational damage.

Existing compliance management systems generally fall into two categories: audit automation and security monitoring. Audit automation tools assist in consolidating compliance artifacts from various departments into a central workspace for review and presentation to external auditors. However, they require significant manual effort to map controls to compliance frameworks and system configurations. On the other hand, security monitoring tools focus on identifying deviations in IT systems but often lack integration with compliance frameworks and do not provide automated remediation capabilities.

These current solutions present several limitations. First, the initial setup and configuration of compliance controls are cumbersome and labor-intensive. Compliance teams must manually map each control to corresponding system inputs, outputs, and logs. This mapping process is not only time-consuming but also requires deep expertise in both compliance standards and the organization's IT environment. Additionally, these systems do not offer real-time monitoring and alerting, which is crucial for promptly addressing compliance issues as they arise.

Furthermore, existing systems typically do not provide automated remediation for detected non-conformities. This means that compliance teams must manually intervene to correct issues, which can lead to delays and increased risk of non-compliance during the remediation process. The lack of automation in generating and managing compliance reports also adds to the administrative burden, making it challenging for organizations to maintain an up-to-date compliance posture.

The integration of machine learning in security compliance monitoring is still in its infancy. Although some solutions have started to incorporate predictive analytics, they are not yet widely adopted, and their effectiveness is limited by the quality and extent of the training data available. Moreover, these systems often lack the capability to operate seamlessly across different types of IT environments, such as Infrastructure as a Service (IaaS), Platform as a Service (PaaS), Software as a Service (Saas), and on-premise systems, which are commonly found in modern enterprises.

As organizations continue to expand their use of cloud services and digital platforms, the complexity of maintaining compliance will only increase. There is a pressing need for a comprehensive, automated solution that not only simplifies the initial setup and configuration of compliance controls but also provides continuous real-time monitoring, alerting, and remediation. Such a system should leverage advanced technologies like machine learning to predict and address potential compliance issues proactively and should integrate seamlessly with a wide range of IT environments.

The development of an automated security compliance monitoring system that addresses these challenges can significantly enhance an organization's ability to comply with regulatory standards. By reducing the manual effort required, providing real-time insights, and enabling automated remediation, such a system would help organizations maintain a robust compliance posture, mitigate risks, and allocate resources more efficiently.

It is within this context that the present invention is provided.

### SUMMARY

The present invention relates to a system and method for automating security compliance monitoring and remediation. The system integrates multiple components, including auto-discovery agents, a repository of compliance standards, a data repository, a real-time monitoring system, an engine for automated remedial actions, a client with an embedded monitoring agent, and an interface for executing remedial actions. The invention facilitates continuous monitoring and assessment of compliance with established standards, enables real-time alerting, and supports automated remediation of compliance issues, thus reducing the need for manual intervention and enhancing the efficiency and accuracy of compliance management.

In some embodiments, the interface for executing remedial actions is a one-click resolution interface. This interface allows predefined scripts or playbooks to be executed with a single click, restricts access to privileged users, and logs all actions for audit purposes. This feature simplifies the remediation process and ensures accountability and traceability of actions taken.

In further embodiments, the auto-discovery agents are configured to interface with various computing environments, including infrastructure as a service (IaaS), platform as a service (PaaS), software as a service (Saas), and on-premise systems. This flexibility allows the system to integrate with diverse IT infrastructures, making it applicable to a wide range of organizational contexts.

In yet further embodiments, the repository of compliance standards is configured to update and verify compliance frameworks through checksums or cryptographic signatures. This ensures the integrity and authenticity of the compliance standards, reducing the risk of using outdated or tampered frameworks.

In some embodiments, the auto-discovery agents use standardized protocols, such as Simple Network Management Protocol (SNMP), Syslog, MQTT or Application Programming Interface (API) calls, to interact with various systems. This standardization facilitates seamless data collection and integration across different systems and devices.

In further embodiments, the data repository implements transaction logging and data validation rules to ensure data integrity. This ensures that all changes to control statuses are accurately recorded and validated, providing a reliable record of compliance status.

In yet further embodiments, the real-time monitoring system employs a microservices architecture to handle data collection, analysis, and alerting. This architectural approach enhances the scalability and reliability of the monitoring system, allowing it to handle large volumes of data efficiently. This also ensures the complete processing and storing elements can be deployed onto the client's VPC itself. This ensures the data security and privacy requirements of fintexh, healthcare, logistics and automotive industries

In some embodiments, the real-time monitoring system uses message queues to manage data flow between microservices. This ensures smooth and efficient data processing and enhances the system's ability to scale and adapt to varying workloads. The addition of Topic and priority in this topology presents a robust and near real-time capabilities.

In further embodiments, the machine learning models used in the system are trained using historical compliance data, including logs of past compliance issues, configuration changes, and remediation actions. These models predict potential non-conformities and trigger preventive actions, improving the system's proactive compliance capabilities.

In yet further embodiments, the engine for automated remedial actions includes multi-factor authentication and approval workflows for executing critical actions. This ensures that only authorized personnel can perform high-impact actions, thereby enhancing the security of the remediation process.

In some embodiments, the automated remedial actions include resetting passwords for compromised accounts, updating firewall rules to block unauthorized IP addresses, and applying software patches to fix security vulnerabilities. These automated actions help to quickly and effectively address common compliance issues.

In further embodiments, the monitoring agent embedded within the client collects data related to compliance, including system logs, configuration files, and security events. This comprehensive data collection ensures that the system has a complete view of the compliance status across the IT infrastructure.

In yet further embodiments, the monitoring agent uses secure communication protocols, such as Transport Layer Security (TLS), to transmit data to the real-time monitoring system. This ensures the confidentiality and integrity of the data during transmission.

In some embodiments, the client comprises a web application that provides a user interface for managing compliance monitoring. This interface allows users to easily interact with the system and access compliance data and reports.

In further embodiments, the system includes a centralized dashboard that displays real-time alerts, compliance statuses, and generated reports. This provides users with a comprehensive and up-to-date view of their compliance posture.

In yet further embodiments, the real-time monitoring system generates alerts based on deviations from compliance standards and logs these events in the data repository. This ensures timely identification and recording of compliance issues.

In some embodiments, the repository of compliance standards includes templates for various industry compliance standards, such as ISO27001, ISO27701, SOC2, PCI-DSS, GDPR, and HIPAA. This wide range of templates ensures that the system can be used to comply with multiple regulatory frameworks.

In further embodiments, the system supports deployment on a Virtual Private Cloud (VPC) to ensure secure integration with existing IT infrastructures. This enhances the security and isolation of the compliance monitoring system.

In yet further embodiments, the system includes an auditor module that reviews compliance reports generated by the system and surfaces point-in-time log events for random sampling within the audit period. This facilitates thorough and effective auditing processes.

In some embodiments, the automated remedial action engine is capable of interfacing with cloud service providers to initiate, configure, and verify patches and other compliance-related configurations. This capability enhances the system's ability to maintain compliance in dynamic and complex cloud environments.

### BRIEF DESCRIPTION OF THE DRAWINGS

Various embodiments of the invention are disclosed in the following detailed description and accompanying drawings.

FIG. 1 illustrates an example system architecture for the Security Compliance Monitor, including its various components and their interactions.

FIG. 2 illustrates an example detailed implementation of the system architecture, showing the integration with various cloud services and compliance standards.

FIG. 3 illustrates an example detailed process flow diagram for the system, depicting the interactions and data flows between the various components involved in compliance monitoring and remediation.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### DEFINITIONS

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The term “auto-discovery agents” refers to software modules configured to interface with various computing environments, such as infrastructure as a service (IaaS), platform as a service (PaaS), software as a service (Saas), and on-premise systems. These agents collect configuration and status data and transmit it to a central system for further processing. In one example implementation, an auto-discovery agent may use Simple Network Management Protocol (SNMP) or Application Programming Interface (API) calls to gather information about network devices and services, periodically scanning and identifying connected components, and classifying them into categories such as databases, web servers, and applications.

The term “repository” refers to a structured database that stores templates for compliance standards, mapping compliance controls to technical requirements and logging specifications. This repository can be updated and verified through checksums or cryptographic signatures to ensure data integrity and authenticity. In one example implementation, the repository may include pre-configured templates for industry standards like ISO27001, PCI-DSS, and HIPAA, which can be accessed and updated via RESTful APIs to ensure that the compliance tools operate with the latest standards.

The term “data repository” refers to a storage system for control status information, including control ID, status, last updated timestamp, associated system, and compliance framework. This repository is designed to receive continuous updates and log changes to control statuses, ensuring data integrity through transaction logging and data validation rules. In one example implementation, the data repository may use a relational database management system (RDBMS) to organize and maintain control status records, allowing for efficient querying and retrieval of compliance information.

The term “real-time monitoring system” refers to a software architecture designed to collect, analyze, and process data from auto-discovery agents in real-time, identifying deviations from compliance standards, generating alerts, and logging events. This system may employ a microservices architecture, where individual services handle specific tasks such as data collection, analysis, and alerting. In one example implementation, the real-time monitoring system may use message queues to manage data flow between microservices, ensuring scalable and reliable data processing.

The term “machine learning models” refers to computational models trained using historical compliance data to predict potential non-conformities. These models may include classification algorithms, anomaly detection models, and reinforcement learning agents. In one example implementation, the machine learning models may analyze logs of past compliance issues, configuration changes, and remediation actions to identify patterns and correlations, enabling the system to predict and proactively address compliance risks.

The term “engine for automated remedial actions” refers to a rule-based system that executes predefined remedial actions in response to detected compliance issues. This engine includes multi-factor authentication and approval workflows to ensure that critical actions are performed securely and only by authorized personnel. In one example implementation, the engine may reset passwords for compromised accounts, update firewall rules to block unauthorized IP addresses, or apply software patches to fix security vulnerabilities.

The term “monitoring agent” refers to a software component embedded within a client device, responsible for collecting data related to compliance and transmitting it to the real-time monitoring system. The monitoring agent uses secure communication protocols, such as Transport Layer Security (TLS), to ensure the confidentiality and integrity of the data during transmission. In one example implementation, the monitoring agent may collect system logs, configuration files, and security events from various devices within the network and securely transmit this data to the central monitoring system.

The term “interface for executing remedial actions” refers to a user interface that allows authorized users to trigger predefined scripts or playbooks to address compliance issues. This interface restricts access to privileged users and logs all actions taken for audit purposes. In one example implementation, the interface may be a one-click resolution dashboard that enables users to quickly resolve access control violations, key rotations, and other compliance-related issues with a single action.

### DESCRIPTION OF DRAWINGS

The present invention pertains to a system and method for automating security compliance monitoring and remediation across various computing environments. This invention addresses several shortcomings of the prior art, including the significant manual effort required for compliance setup and monitoring, the inefficiency and error-proneness of these manual processes, and the lack of real-time monitoring and automated remediation capabilities.

Existing compliance management systems typically fall into two categories: audit automation and security monitoring. Audit automation tools consolidate compliance artifacts from various departments into a central workspace, facilitating review and presentation to external auditors. However, these tools require extensive manual mapping of controls to compliance frameworks and system configurations. Security monitoring tools, on the other hand, focus on identifying deviations in IT systems but often lack integration with compliance frameworks and do not provide automated remediation.

The present invention overcomes these limitations by integrating several key components: auto-discovery agents, a repository of compliance standards, a data repository for control statuses, a real-time monitoring system, machine learning models for predictive analysis, an engine for automated remedial actions, a client with an embedded monitoring agent, and a secure interface for executing remedial actions. These components work together to provide continuous, real-time monitoring and assessment of compliance with established standards, enable automated remediation of compliance issues, and reduce the need for manual intervention.

The system's auto-discovery agents interface with various computing environments, including infrastructure as a service (IaaS), platform as a service (PaaS), software as a service (Saas), and on-premise systems. These agents collect configuration and status data, allowing the system to maintain an up-to-date view of the entire IT infrastructure. The repository of compliance standards stores templates that map compliance controls to technical requirements and logging specifications, ensuring that the system operates with the most current standards.

The real-time monitoring system collects and analyzes data from the auto-discovery agents, identifying deviations from compliance standards, generating alerts, and logging events. This system employs a microservices architecture and message queues to manage data flow between components, ensuring scalability and reliability. Machine learning models, trained using historical compliance data, predict potential non-conformities and trigger preventive actions, enhancing the system's proactive compliance capabilities.

The engine for automated remedial actions includes multi-factor authentication and approval workflows for executing critical actions, ensuring that only authorized personnel can perform high-impact operations. The embedded monitoring agent within the client collects compliance-related data and transmits it securely to the real-time monitoring system. The secure interface allows authorized users to trigger predefined scripts or playbooks for remedial actions, simplifying the remediation process and ensuring accountability and traceability.

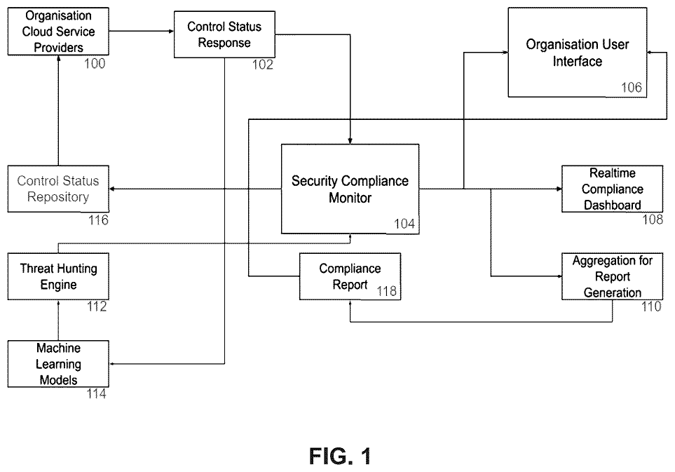

Referring now to the drawings, FIG. 1 illustrates an example architecture of the Security Compliance Monitor system.

The Organisation Cloud Service Providers 100 interface with the Control Status Response 102, which communicates control status information back to the Security Compliance Monitor 104. This interaction ensures that the system maintains an up-to-date view of compliance status across various cloud services.

The Control Status Response 102 also interacts with the Organisation Cloud Service Providers 100 to receive data. This data includes configuration and status information collected by the auto-discovery agents embedded within the infrastructure. These auto-discovery agents are responsible for periodically scanning the network, identifying connected devices and services, and classifying them into categories such as databases, web servers, and applications. The collected data is transmitted securely to the Control Status Response 102.

The Security Compliance Monitor 104 serves as the central component of the system, overseeing the entire compliance monitoring process. It processes the data received from the Control Status Response 102 and integrates it with information from other components. The Security Compliance Monitor 104 is linked to the Organisation User Interface 106, providing users with access to compliance data, alerts, and reports. The Organisation User Interface 106 allows users to interact with the system, review compliance statuses, and manage remediation actions.

The Realtime Compliance Dashboard 108, connected to the Security Compliance Monitor 104, displays real-time alerts and compliance statuses. This dashboard enables continuous monitoring and immediate identification of compliance issues, ensuring timely response and mitigation.

Data aggregation for report generation is managed by the Aggregation for Report Generation module 110. This module compiles data from various sources, including the Security Compliance Monitor 104, to generate comprehensive compliance reports 118. These reports provide detailed insights into the organization's compliance posture, aiding in audits and assessments.

The Threat Hunting Engine 112, informed by Machine Learning Models 114, interacts with the Security Compliance Monitor 104 to enhance the system's proactive compliance capabilities. The machine learning models 114 are trained using historical compliance data, such as logs of past compliance issues, configuration changes, and remediation actions. These models predict potential non-conformities and enable the system to trigger preventive actions, improving the overall security posture.

Control status information is stored in the Control Status Repository 116. This repository maintains a record of each control, including its ID, status, last updated timestamp, associated system, and compliance framework. The repository implements transaction logging and data validation rules to ensure data integrity, providing a reliable source of compliance information.

The system also supports automated remedial actions through a dedicated engine integrated with the Security Compliance Monitor 104. This engine executes predefined remedial actions in response to detected compliance issues. For example, it can reset passwords for compromised accounts, update firewall rules to block unauthorized IP addresses, and apply software patches to fix security vulnerabilities. The engine includes multi-factor authentication and approval workflows, ensuring that only authorized personnel can execute critical actions.

The client component, comprising a monitoring agent, interacts with the cloud-based services. The monitoring agent collects data related to compliance, including system logs, configuration files, and security events. It transmits this data securely to the Security Compliance Monitor 104 using protocols such as Transport Layer Security (TLS). This ensures the confidentiality and integrity of the data during transmission.

An interface is also provided for executing remedial actions. This one-click resolution interface allows users to trigger predefined scripts or playbooks to address compliance issues. Access to the interface is restricted to privileged users, and all actions taken are logged for audit purposes. This feature simplifies the remediation process, ensuring accountability and traceability of actions taken.

The Compliance Report 118 generated by the system provides a detailed overview of the compliance status and any detected issues. This report is accessible to auditors and other stakeholders, facilitating thorough reviews and assessments.

In an example method of implementation, the auto-discovery agents embedded within the client's infrastructure periodically scan the network, identifying and classifying connected devices and services. The data collected by these agents is transmitted to the Control Status Response 102, which updates the Control Status Repository 116. The real-time monitoring system within the Security Compliance Monitor 104 analyzes this data, identifying deviations from compliance standards and generating alerts. Machine learning models 114 predict potential non-conformities, triggering preventive actions through the automated remedial action engine. Users can access compliance data and manage remediation actions via the Organisation User Interface 106 and the one-click resolution interface, ensuring efficient and effective compliance management.

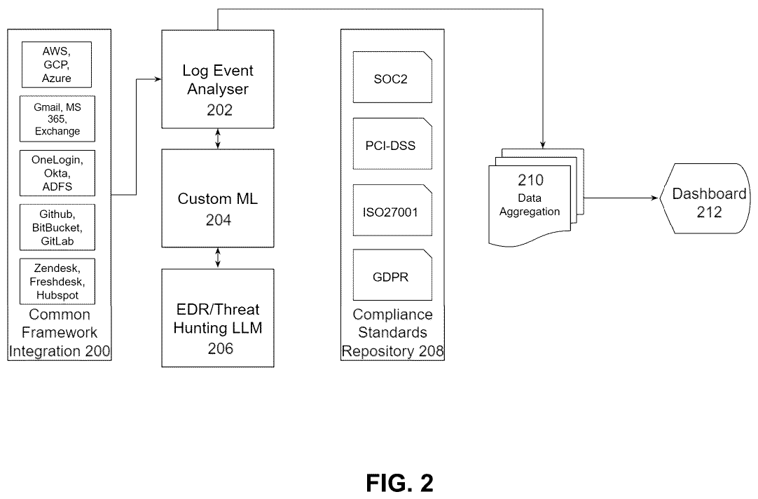

FIG. 2 illustrates an example detailed implementation of the system architecture shown in FIG. 1, expanding on the integration with various cloud services and compliance standards. A common framework integration 200 allows for connection to various third parties including AWS, GCP, Azure, Gmail, MS 365, Exchange, OneLogin, Okta, ADFS, Github, BitBucket, GitLab, Zendesk, Freshdesk, and Hubspot. These integrations facilitate comprehensive data collection and compliance monitoring across diverse platforms.

The collected data from these cloud service providers is transmitted to the Log Event Analyser 202. This component processes log events to identify relevant security and compliance information. The Log Event Analyser 202 interacts with a Custom Machine Learning module 204, which utilizes machine learning models trained on historical compliance data to predict potential non-conformities and enhance proactive compliance measures.

The Custom Machine Learning module 204 further communicates with the EDR/Threat Hunting LLM 206. This component employs advanced threat hunting techniques and Endpoint Detection and Response (EDR) to detect and mitigate security threats, thereby strengthening the overall compliance posture.

The Compliance Standards Repository 208 stores templates for various industry compliance standards, such as SOC2, PCI-DSS, ISO27001, and GDPR. The repository provides a reference for the Log Event Analyser 202 and Custom Machine Learning module 204 to ensure that all collected data and identified events are evaluated against the appropriate compliance frameworks.

Data Aggregation 210 collects and consolidates processed data from the Log Event Analyser 202 and other components, preparing it for presentation and reporting. This aggregated data is then fed into the Dashboard 212, which provides a user interface for real-time compliance monitoring, alerts, and detailed compliance reports.

In an example implementation, the Log Event Analyser 202 receives log data from the integrated cloud service providers and processes it to identify events relevant to compliance. The Custom Machine Learning module 204 analyzes these events, using trained models to predict and highlight potential non-compliance issues. The EDR/Threat Hunting LLM 206 actively searches for security threats and implements mitigation strategies. The Compliance Standards Repository 208 ensures that all evaluations are in line with current compliance standards. Data Aggregation 210 compiles this information, and the Dashboard 212 displays it to users, allowing for continuous monitoring and management of compliance status across the organization's IT infrastructure.

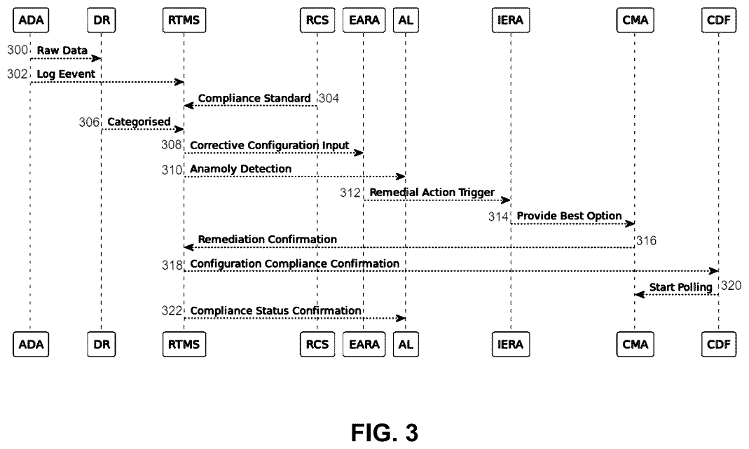

FIG. 3 illustrates a detailed process flow diagram for the system, showcasing the interactions and data flows between various components. The process begins when the Auto-discovery Agents ADA send raw data to the Data Repository DR in step 300. The raw data includes configuration and status information collected from various computing environments.

In step 302, the Auto-discovery Agents ADA also send categorized log events to the Data Repository DR. These log events are organized based on predefined categories to facilitate further analysis.

In step 304, the Real-time Monitoring System RTMS retrieves the compliance standards from the Repository of Compliance Standards RCS. This retrieval ensures that the system has the most current compliance frameworks to evaluate the collected data.

The Real-time Monitoring System RTMS then processes the categorized log events to generate corrective configuration input in step 306. This input is based on the compliance standards retrieved earlier and aims to correct any deviations identified in the log events.

In step 308, the Real-time Monitoring System RTMS performs anomaly detection on the categorized log events. This step involves analyzing the data to identify any unusual patterns or behaviors that could indicate potential compliance issues.

Upon detecting an anomaly, the Real-time Monitoring System RTMS sends a remedial action trigger to the Engine for Automated Remedial Actions EARA in step 310. This trigger prompts the engine to initiate predefined remedial actions to address the detected issues.

In step 312, the Engine for Automated Remedial Actions EARA provides the best option for remediation to the Interface for Executing Remedial Actions IERA. This step involves selecting the most appropriate remedial action based on the nature of the detected anomaly and the available corrective measures.

The Interface for Executing Remedial Actions IERA then confirms the remediation action in step 314. This confirmation ensures that the selected remedial action has been successfully executed and that the compliance issue has been addressed.

Following the remediation confirmation, the Real-time Monitoring System RTMS receives a configuration compliance confirmation from the Engine for Automated Remedial Actions EARA in step 316. This step verifies that the system configurations have been adjusted to comply with the relevant standards.

In step 318, the Real-time Monitoring System RTMS sends a compliance status confirmation to the Data Repository DR. This confirmation updates the status of the compliance controls in the repository, reflecting the current compliance posture of the organization.

Simultaneously, the Client with Monitoring Agent CMA starts polling for updated compliance status in step 320. This polling ensures that the client has the latest information regarding the organization's compliance status.

Finally, the Compliance Data Flow CDF receives the updated compliance status from the Client with Monitoring Agent CMA in step 322. This data flow updates the compliance dashboard, providing real-time visibility into the compliance status across the organization.

### Controller/Processor Components

The operations described herein may be implemented via one or more servers and user devices. A server and user device as described herein can be any suitable type of computer. A computer may be a uniprocessor or multiprocessor machine. Accordingly, a computer may include one or more processors and, thus, the aforementioned computer system may also include one or more processors. Examples of processors include sequential state machines, microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), gated logic, programmable control boards (PCBs), and other suitable hardware configured to perform the various functionality described throughout this disclosure.

Additionally, the computer may include one or more memories. Accordingly, the aforementioned computer systems may include one or more memories. A memory may include a memory storage device or an addressable storage medium which may include, by way of example, random access memory (RAM), static random access memory (SRAM), dynamic random access memory (DRAM), electronically erasable programmable read-only memory (EEPROM), programmable read-only memory (PROM), erasable programmable read-only memory (EPROM), hard disks, floppy disks, laser disk players, digital video disks, compact disks, video tapes, audio tapes, magnetic recording tracks, magnetic tunnel junction (MTJ) memory, optical memory storage, quantum mechanical storage, electronic networks, and/or other devices or technologies used to store electronic content such as programs and data. In particular, the one or more memories may store computer executable instructions that, when executed by the one or more processors, cause the one or more processors to implement the procedures and techniques described herein. The one or more processors may be operably associated with the one or more memories so that the computer executable instructions can be provided to the one or more processors for execution. For example, the one or more processors may be operably associated to the one or more memories through one or more buses. Furthermore, the computer may possess or may be operably associated with input devices (e.g., a keyboard, a keypad, controller, a mouse, a microphone, a touch screen, a sensor) and output devices such as (e.g., a computer screen, printer, or a speaker).

The computer may advantageously be equipped with a network communication device such as a network interface card, a modem, or other network connection device suitable for connecting to one or more networks.

A computer may advantageously contain control logic, or program logic, or other substrate configuration representing data and instructions, which cause the computer to operate in a specific and predefined manner as, described herein. In particular, the computer programs, when executed, enable a control processor to perform and/or cause the performance of features of the present disclosure. The control logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro code, circuitry, data, and/or the like.

The control logic conventionally includes the manipulation of digital bits by the processor and the maintenance of these bits within memory storage devices resident in one or more of the memory storage devices. Such memory storage devices may impose a physical organization upon the collection of stored data bits, which are generally stored by specific electrical or magnetic storage cells.

The control logic generally performs a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, files, or the like. It should be kept in mind, however, that these and some other terms should be associated with appropriate physical quantities for computer operations, and that these terms are merely conventional labels applied to physical quantities that exist within and during operation of the computer based on designed relationships between these physical quantities and the symbolic values they represent.

It should be understood that manipulations within the computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general-purpose computing machines or devices may be used with programs constructed in accordance with some of the teachings described herein. In some embodiments, very specific computing machines, with specific functionality, may be required.

### CONCLUSION

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the system and methods of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A system for automating security compliance monitoring, comprising:
a plurality of auto-discovery agents configured to interface with various computing environments, wherein the auto-discovery agents collect and transmit configuration and status data;
a repository comprising templates for compliance standards, wherein the templates map compliance controls to technical requirements and logging specifications, wherein each template includes control identifiers that are validated against control status information;
a data repository configured to store control status information, wherein the data repository receives updates and logs changes to control statuses, including control ID, status, last updated timestamp, associated system, and compliance framework;
a real-time monitoring system configured to collect and analyze data from the auto-discovery agents, identify deviations from compliance standards, generate alerts, and log events;
an engine configured to execute automated remedial actions for compliance issues, wherein the automated remedial actions are executed based on predefined remediation rules without requiring manual intervention;
a client comprising a monitoring agent, wherein the monitoring agent collects data related to compliance and transmits the data to the real-time monitoring system;
an interface configured to execute remedial actions, wherein access to the interface is restricted and actions are logged.

2. The system of claim 1, wherein the interface configured to execute remedial actions is a one-click resolution interface that executes predefined scripts or playbooks for common remedial actions, restricts access to privileged users, and logs all actions taken for audit purposes.

3. The system of claim 1, wherein the computing environments include infrastructure as a service (IaaS), platform as a service (PaaS), software as a service (Saas), and on-premise systems.

4. The system of claim 1, wherein the repository is configured to update and verify compliance frameworks through checksums or cryptographic signatures.

5. The system of claim 1, wherein the auto-discovery agents use standardized protocols, including Simple Network Management Protocol (SNMP) or Application Programming Interface (API) calls, to interact with various systems.

6. The system of claim 1, wherein the data repository implements transaction logging and data validation rules to ensure data integrity.

7. The system of claim 1, wherein the real-time monitoring system uses a microservices architecture to handle data collection, analysis, and alerting.

8. The system of claim 7, wherein the real-time monitoring system uses message queues to manage data flow between microservices, ensuring scalability and reliability.

9. The system of claim 1, wherein the machine learning models are trained using historical compliance data, including logs of past compliance issues, configuration changes, and remediation actions, to predict potential non-conformities.

10. The system of claim 1, wherein the engine configured to execute automated remedial actions includes multi-factor authentication and approval workflows for executing critical actions.

11. The system of claim 1, wherein the automated remedial actions include resetting passwords for compromised accounts, updating firewall rules to block unauthorized IP addresses, and applying software patches to fix security vulnerabilities.

12. The system of claim 1, wherein the monitoring agent embedded within the client collects data related to compliance, including system logs, configuration files, and security events.

13. The system of claim 1, wherein the monitoring agent uses secure communication protocols, including Transport Layer Security (TLS), to transmit data to the real-time monitoring system.

14. The system of claim 1, wherein the client comprises a web application that provides a user interface for managing compliance monitoring.

15. The system of claim 1, further comprising a centralized dashboard that displays real-time alerts, compliance statuses, and generated reports.

16. The system of claim 1, wherein the real-time monitoring system generates alerts based on deviations from compliance standards and logs these events in the data repository.

17. The system of claim 1, wherein the repository of compliance standards includes templates for industry compliance standards such as ISO27001, ISO27701, SOC2, PCI-DSS, GDPR, and HIPAA.

18. The system of claim 1, wherein the system supports deployment on a Virtual Private Cloud (VPC) to ensure secure integration with existing IT infrastructures.

19. The system of claim 1, further comprising an auditor module that reviews compliance reports generated by the system and surfaces point-in-time log events for random sampling within the audit period.

20. The system of claim 1, wherein the automated remedial action engine is capable of interfacing with cloud service providers to initiate, configure, and verify patches and other compliance-related configurations.
